(19) United States
(12) Patent Application Publication
(10) Pub. No.: US 2014/0064085 A1
(43) Pub. Date: Mar. 6, 2014

(54) COMMUNICATION NODE AND COMMUNICATION METHOD

(71) Applicant: FUJITSU LIMITED, Kawasaki-shi (JP)

(72) Inventor: Yuuta NAKAYA, Beijing (CN)

(73) Assignee: FUJITSU LIMITED, Kawasaki-shi (JP)

(21) Appl. No.: 14/035,476

(22) Filed: Sep. 24, 2013

Related U.S. Application Data
(63) Continuation of application No. PCT/JP2011/057916, filed on Mar. 29, 2011.

(51) Int. Cl. H04L 12/801

(52) U.S. Cl. CPC H04L 47/10
USPC 370/235

(57) ABSTRACT

A communication node that is capable of preventing a packet collision from occurring is provided. In a wireless network that connects a plurality of communication nodes in a multi-hop fashion, the communication node selects a high-communication-quality frequency to be used for transmission, sets frequency information in a channel assignment information part of a packet, and transmits the packet to a communication node that is a next hop destination. The communication node may recognize the frequency used for each hop from the frequency information set in the channel assignment information part of the received packet. Recognizing the frequency used for each hop, the apparatus may prevent the use of a frequency that could cause a hidden-terminal problem.

### CROSS-REFERENCE TO RELATED APPLICATION

This application is a continuation application of International PCT Application No. PCT/JP2011/057916 which was filed on Mar. 29, 2011.

### FIELD

The embodiments discussed herein are related to a wireless communication technology for performing a communication between a plurality of wireless communication apparatuses.

### BACKGROUND

Technologies related to multi-hop data transmission in a wireless communication network that includes a plurality of communication apparatuses have been researched.

For example, research has been conducted on a multi-hop data communication in a distributed autonomous network such as an adhoc network in which communication apparatuses that function as a terminal (hereinafter may be referred to as “communication nodes” or “nodes” as appropriate) are directly connected to each other so as to construct the network.

FIG. 1 illustrates the entire configuration of a wireless network formed by a plurality of communication nodes in a multi-hop communication.

Communication nodes 10-1 to 10-5 are connected via a wireless link, and the number of hops is 1 between the communication nodes 10-1 and 10-2, between the communication nodes 10-2 and 10-3, between the communication nodes 10-3 and 10-4, and between the communication nodes 10-4 and 10-5. The communication nodes 10-1 to 10-5 each include a transmitting unit 11 and a receiving unit 12. In such a wireless network, in order to prevent wireless links between the communication nodes 10-1 to 10-5 from causing interference and in order to relieve communication congestion, the wireless network apparatuses 10-1 to 10-5 may each use a different frequency for transmission or reception.

However, since frequency resources are limited, a routing protocol is used that allows the same frequency to be used by allocating a frequency to the communication nodes 10-1 to 10-5 in a manner such that wireless links for the same frequency do not interfere with each other. Thus, each of the communication nodes 10-1 to 10-5 and other communication nodes around it use a unique frequency for transmission or reception, but they may use the same frequency when the wireless links do not cause interference.

A gateway of the wireless network serves to collect data from other communication nodes, but its device configuration is the same as the other communication nodes. For communication processing, data collected by the nodes concentrates on the gateway.

A wireless network system that performs a multi-hop transfer such as illustrated in FIG. 1 uses a scheme wherein, at the moment when routing information is read from received packets, the currently received packets are sequentially copied and transferred to a next hop destination while packets are being received (this scheme is referred to as “a cut-and-through scheme” herein). Such a process may decrease processing delay.

FIGS. 2A and 2B illustrate a cut-and-through scheme.

FIG. 2A illustrates a packet format.

A packet is composed of routing information, data, and CRC (Cyclic Redundancy Check). A data part is a portion in which user data is stored, and a CRC part is a redundant bit of an error correcting code. A routing information part designates an address of a destination communication node that a destination of the packet.

As described above, in the cut-and-through scheme, at the moment when routing information is read from received packets, packets to-be transmitted start to be generated and are sequentially transmitted even while packets are being received. In this example, the wireless network that achieves the cut-and-through scheme employs an FDD (Frequency Division Duplex) scheme.

FIG. 2B illustrates a problem of the cut-and-through scheme.

In FIG. 2B, communication nodes are depicted as nodes A to D. Assume that, under a condition in which the initial source node is the node A and the final destination node is the node D, a frequency f₁ is used for the transmission from the node A to the node B and a frequency f₂ is used for the transmission from the node B to the node C in the transferring of a packet from the node A to the node D. FIG. 2B illustrates a packet transmission under the cut-and-through scheme, and, on the assumption that the horizontal axis indicates a time, the timings of the transmitting or receiving of a packet are overlapped. The period from the end of packet transmission from the transmission node A to the-completion of the receiving of the packet by the final destination node D is depicted as latency.

In the meantime, when the node C is distant and thus cannot directly receive a signal from the node A (this is called a “hidden-terminal problem”), carrier-sensing is performed to determine that the frequency f₁ used by the node A is an available channel. Then, it maybe confirmed that a signal with the frequency f₁ is not present, and, in an attempt to send a packet to the node D, the packet may be transmitted with the frequency f₁. In this case, since the antenna of each node has no directivity, the node B simultaneously receives the packet from the node A and-the packet from the node B, both having the frequency f₁, with the result that a collision occurs.

FIGS. 3A and 3B illustrate a hidden-terminal problem.

As illustrated in FIG. 3A, a packet is transmitted from the node A with the frequency f₁. For the aforementioned reason, a packet is also transmitted from the node C with the frequency f₁. The antennas used by the nodes do not have directivity, so the packet with the frequency f1 transmitted from the node C is transmitted not only to the node D but also to the node B. Thus, the node B receives the packet with the frequency f₁ from the node A and the packet with the frequency f₁ from the node C. It is intended that only the packet from the node A be received, but the node B is prevented from receiving the packet from the node A.

FIG. 3B schematically illustrates a packet collision.

While a packet is being transmitted with the frequency f₁ from the node A to the node B, a packet starts to be transmitted with the frequency f₂ from the node B to the node C. Similarly, while a packet is being transmitted from the node B to the node C, a packet starts to be transmitted with the frequency f₁ from the node C to the node D. However, the packet transmitted from the node C to the node D is also transmitted to the node B, and hence, at the overlapping portion in FIG. 3B, the node B receives both the packet transmitted from the node C to the node D and the packet transmitted from the node A to the node B. An occurrence of such a packet collision prevents the node B from successfully receiving the packet.

The following patent document relates to a technology that uses a cut-and-through scheme in an adhoc communication network.

### PRIOR ART DOCUMENT

### Patent Document

Patent document 1: Japanese Laid-open Patent Publication No. 2006-174145

### SUMMARY

A communication node in accordance with one aspect of the embodiment is in a network and is capable of using any one of a plurality of transmission frequencies, the network connecting a plurality of communication nodes in a multi-hop fashion and employing a cut-and-through scheme, the communication node including: a transmitting unit that inserts in a packet the information of a frequency used for transmission by the communication node and that transmits this packet to a next-hop-destination communication node; and a frequency selecting unit that selects a frequency not used by another hop in accordance with the information of a frequency inserted in a received packet and that sets this selected frequency as a transmission frequency of the communication node.

The embodiments described in the following may provide a communication node that is capable of preventing a packet collision from occurring.

The object and advantages of the invention will be realized and attained by means of, the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an entire configuration of a wireless network that connects a plurality of wireless terminals in a multi-hop fashion.

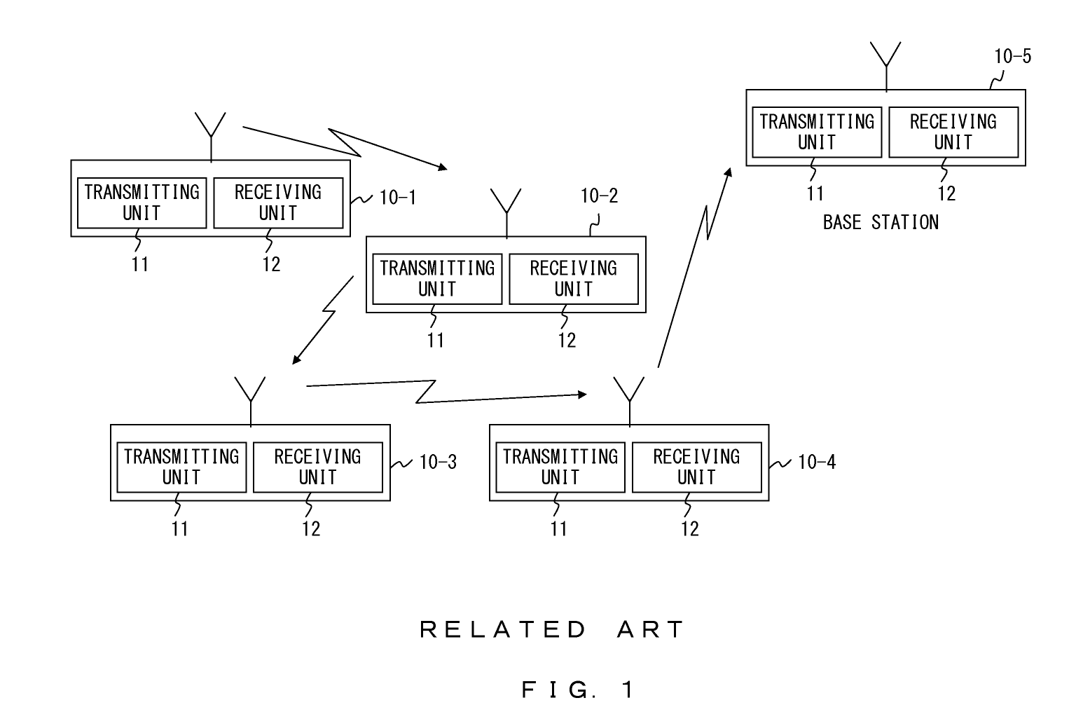

FIGS. 2A and 2B illustrate a cut-and-through scheme.

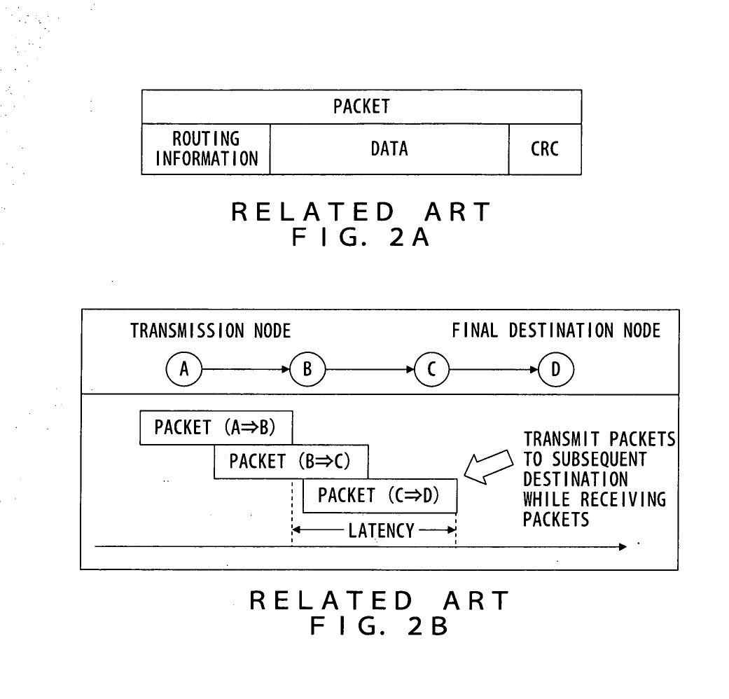

FIGS. 3A and 3B illustrate a hidden-terminal problem.

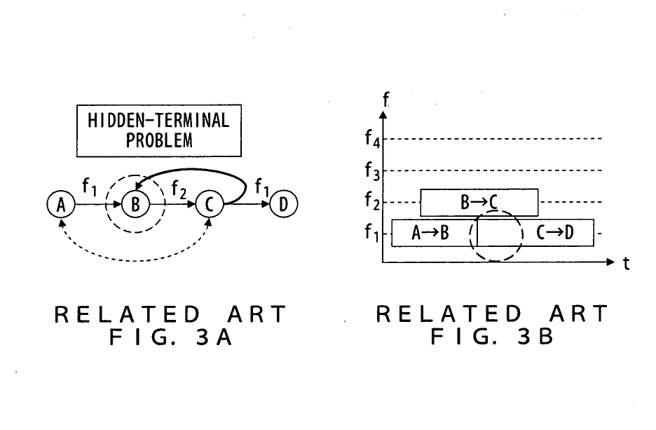

FIG. 4 illustrates the embodiment (pattern 1).

FIGS. 5A and 5B illustrate the embodiment (pattern 2).

FIG. 6 illustrates the embodiment (pattern 3).

FIG. 7 illustrates the embodiment (pattern 4).

### DESCRIPTION OF EMBODIMENTS

In the embodiment, Channel Assign Information (CAI; channel assignment information part) is inserted in a routing information part of a packet, and a used-channel state of a transferred packet is stored. Anode that has received a packet checks the information of CAI and solves a hidden-terminal problem using a channel that has not been used.

The flow of processes includes: waiting for a packet addressed to a self-node to arrive; upon a packet arriving from a source, checking the channel status of the source stored in a channel assignment information part; and selecting a channel with a high communication quality. The channel assignment information part stores an RSSI (Received Signal Strength Indicator; received power) and a CINR (Carrier to Interference plus Noise Ratio; communication quality) of the source, and, using these pieces of information, the channel status of the source may be recognized. For example, when the communication qualities of respective four channels are 0 dB, 10 dB, 20 dB, and 30 dB, the channel with 30 db, i.e., the highest-quality channel, is selected. In ordinary environments, the RSSI is about −90 dBm to −60 dBm, and the CINR is about 0 dB to 30 dB.

Next, the node measures the channel status of itself, adds the resultant information to the channel assignment information part of the packet, and then transfers this packet to a subsequent destination.

Such a configuration solves the hidden-terminal problem, and hence it is estimated that transference delay will decrease and throughput will increase.

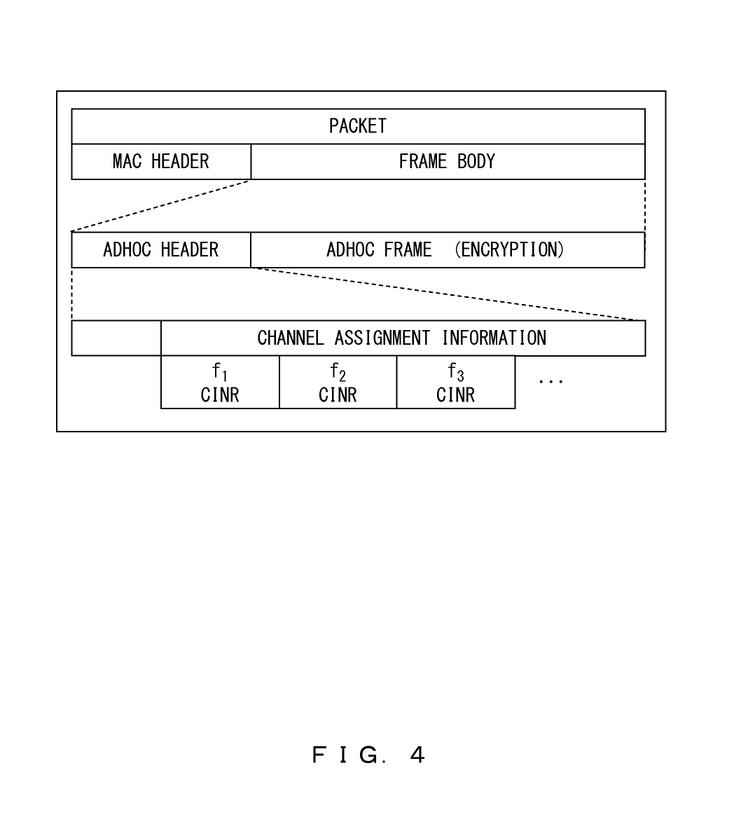

FIG. 4 to FIG. 7 illustrate the embodiment.

The following descriptions will be given on the assumption that nodes A, B, C, D, and E are sequentially wirelessly connected and that the node A is the initial source node and the node E is the final destination node. Note that one or more of the four frequencies f₁ to f₄ are used.

FIG. 4 illustrates a packet format.

The packet is composed of a MAC header and a frame body. The frame body is composed of an adhoc header and an encrypted adhoc frame. The adhoc header is control information to form a multi-hop adhoc network. Channel Assign Information (CAI; channel assignment information part) is provided within the adhoc header. The channel assignment information part stores in sequence: a frequency used at a hop that is the closest to the initial source node and, frequencies used at the other hops; and the communication quality at the source. Together with the information of frequencies, the strength of the received radio waves of the frequencies (an RSSI or CINR used as a communication quality) is set in a frequency setting region. A used frequency is stored in a region that corresponds to a used hop. A measured CINR is stored in a region in which a frequency is not stored.

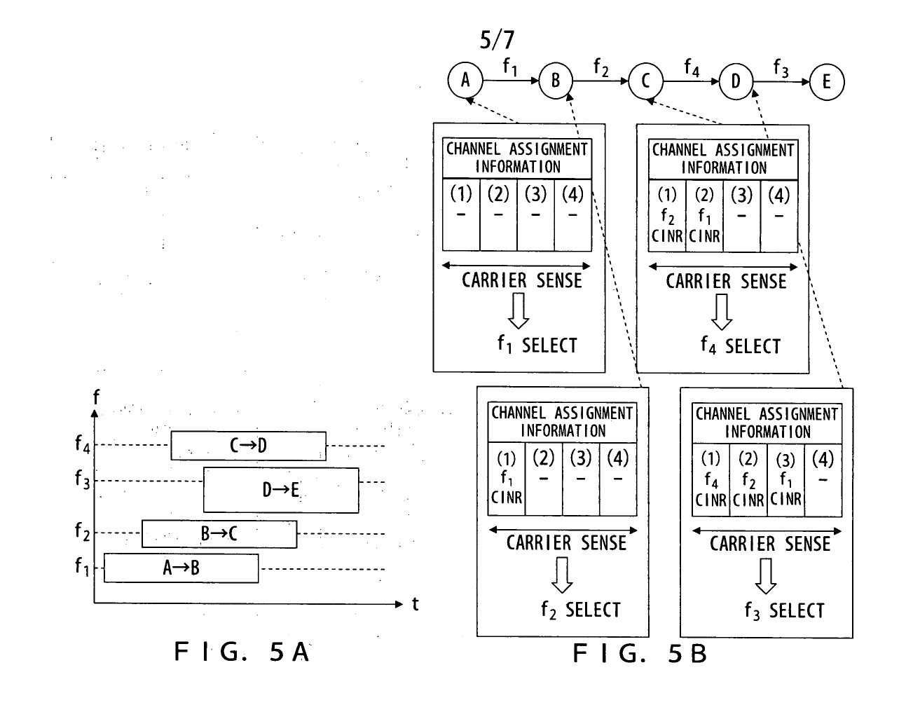

As illustrated in FIG. 5A, a packet transmitted from the node A to the node B, a packet transmitted from the node B to the node C, a packet transmitted from the node C to the node D, and a packet transmitted from the node D to the node E are respectively transmitted with different frequencies f₁ to f₄. FIG. 5B illustrates details of Channel Assign Information (CAI; channel assignment information part) provided in a packet transmitted from each node at this moment. In the present embodiment, the channel assignment information part includes four regions (1) to (4), in which information indicating which frequency is used can be registered for each communication. In the present embodiment, the newest channel assignment information is registered in the region (1), and the second newest channel assignment information, the third newest channel assignment information, and the fourth newest assignment information are respectively registered in the regions (2) to (4). Referring to FIG. 5B, the node A performs carrier-sensing for the four frequencies and selects the frequency f₁. In accordance with the channel assignment information part within the packet received from the node A, the node B may recognize that the frequency f₁ has already been used. Thus, the node B performs carrier-sensing for the frequencies f₂ to f₄ and selects one of the frequencies corresponding to 0 dB (the frequencies that have not been used). In this example, the frequency f₂ is selected.

In accordance with the channel assignment information part from the node B, the node C may recognize that the frequencies f₁ and f₂ have been used. The node C performs carrier-sensing for the frequencies f₃ and f₄ and selects the frequency f₄. In accordance with the channel assignment information part from the node C, the node D may recognize that the frequencies f₁, f₂, and f₄ have been used. Thus, the node D selects the remaining frequency f₃ and transmits a packet to the node E.

In addition to the used frequency, the communication quality detected at the source, such as the CINR of the frequency, is stored in the CAI. When, for example, all of the frequencies have been used, the frequency with the communication quality that is the highest of the communication qualities of these frequencies is selected.

For carrier-sensing, a frequency to be used in the wireless network is set in advance, the strength of received radio waves with the frequency is estimated, and a determination is made as to whether or not a carrier is present in accordance with the strength of radio waves. Such a determination as to whether or not a carrier is present is made by comparing the strength of received radio waves with a threshold determined by the designer in advance for the strength of radio waves.

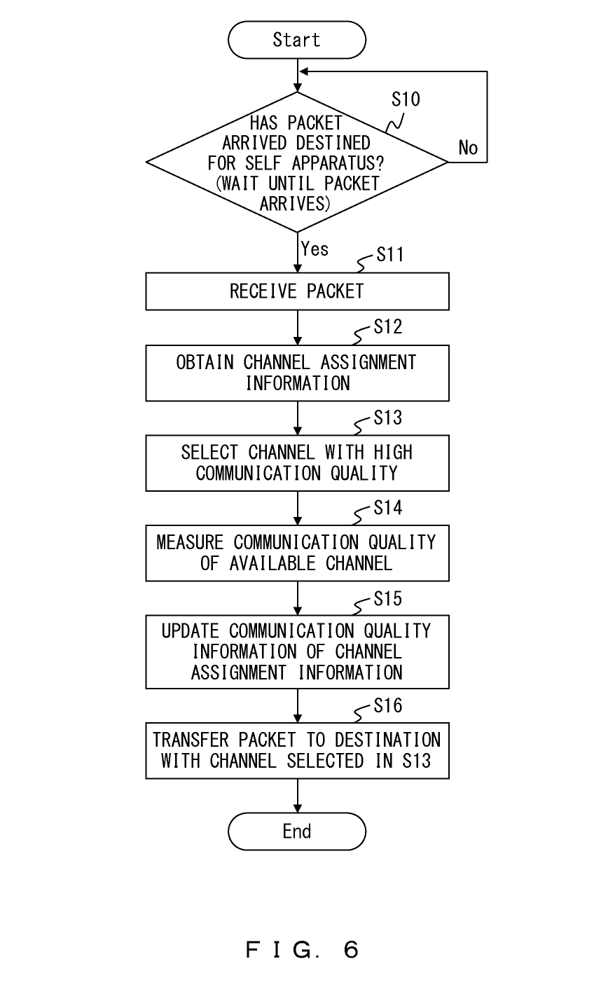

FIG. 6 is a flowchart illustrating an example of processes performed by the communication node in accordance with the present embodiment.

In S10, the communication node determines whether or not a packet addressed to this communication node has arrived. Here, the communication node waits until a packet addressed to this communication node arrives. In S12, when a packet addressed to the communication node is transmitted, the communication node receives this packet. In S12, channel assignment information is obtained. The channel assignment information includes a frequency used by the source and the channel status (the communication quality) of the source. In this example, the channels with the frequencies f₁ to f₄ are available. The communication quality at the source is determined from the communication quality of the channel assignment information.

In S13, a high-communication-quality channel that has not been used is selected. Those channels that have not been used correspond to 0 dB, and one frequency is selected from these. When all of the frequencies have been used, a frequency with a high communication quality is selected from the used frequencies. When all of the frequencies have been used, a high-communication-quality frequency is selected, and the self communication node performs transmission, so it is expected that the communication quality of the frequency will not become too low. When, for example, the channel assignment information obtained in S12 includes the frequency f₁ with CINR=30 dB, the frequency f₂ with CINR=20 dB, the frequency f₃ with Used ChannelI (the channel used by the source), and the frequency f₄ with CINR=0 dB, the frequency (channel) f₄ with CINR=0 dB (supposedly not used) is selected.

In S14, the communication quality of a channel is measured. That is, the communication quality of a channel of the self communication node is measured. For example, when data with a communication quality such as the frequency f₁ with CINR=30 dB, the frequency f₂ with CINR=10 dB, the frequency f₃ with CINR=20 dB, or the frequency f₄ with Used ChannelI (the channel scheduled to be used by the self communication node) is obtained, then, in S15, the communication quality information of the channel assignment information part is updated and inserted in a packet to be transmitted to the subsequent communication node. In S16, the packet is transferred to the destination with the channel selected in S13. In this example, the packet is transmitted with the frequency f₄, and the process ends.

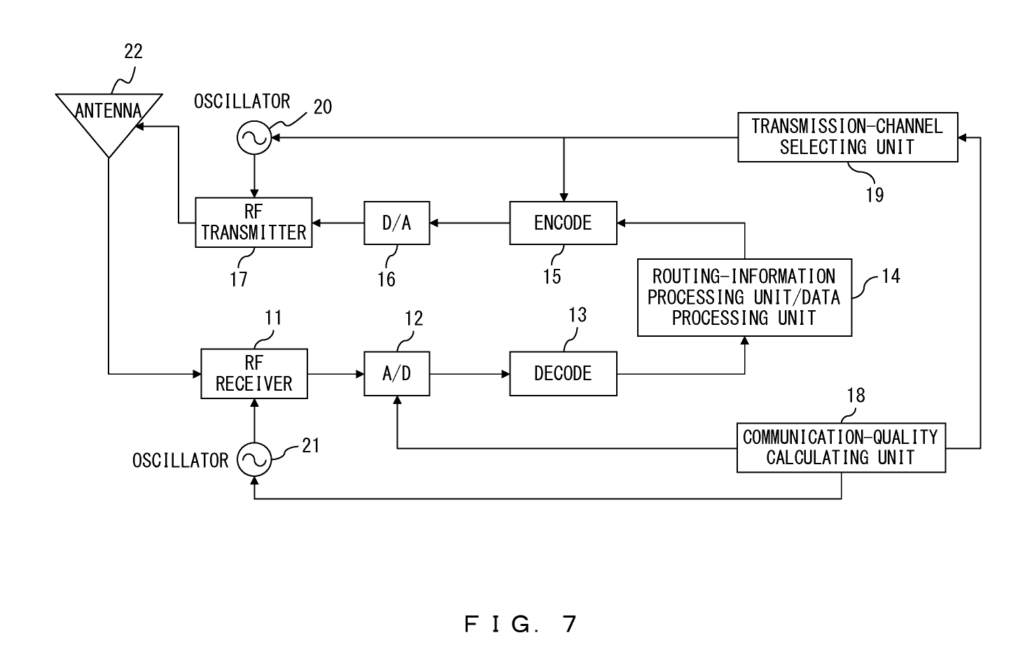

FIG. 7 illustrates a block configuration diagram of a communication node.

In FIG. 7, data received from an antenna 22 is down-converted at an RF receiver 11 and is input to an A/D converter 12. The A/D converter 12 converts an analog signal into a digital signal, which is decoded by a decoder 13. For the decoded data, a routing-information processing unit/data processing unit 14 processes routing information and data. A signal is input from the A/D converter 12 to a communication-quality calculating unit 18, and the communication quality of each channel is measured. The communication quality of each channel is measured by tuning the reception frequency of the antenna to a frequency used in the wireless network and by detecting the strength of received radio waves of the tuned frequency. Determining the ratio between the strength of a signal component within the strength of received radio waves and the other strength allows a CINR to be measured. The communication-quality calculating unit 18 inputs a frequency selection signal to an oscillator 21 and causes oscillation waves with a channel frequency for tuning to a predetermined frequency to be output.

Communication quality information from the communication-quality calculating unit 18 is input to a transmission-channel selecting unit 19. The transmission-channel selecting unit 19 selects a channel with the best communication quality from the communication quality information, and inputs to an oscillator 20 and an encoder 15 a control signal for tuning to the frequency of the selected channel.

The routing-information processing unit/data processing unit 14 generates and inputs transmission data to the encoder 15. The encoder 15 encodes and inputs the transmission data to a D/A converter 16. The D/A converter 16 converts a digital signal into an analog signal, and this analog signal is up-converted by an RF transmitter 17 and is then transmitted from the antenna 22.

The aforementioned embodiments utilize only the information of a frequency that has already been used for transmission, so frequency information of all of the communication nodes that form a network is not needed. Accordingly, since frequency information of a source is also transmitted when the source transmits data, all of the communication nodes that form the network do not need to be aware of frequency information of all of the communication nodes, with the result that frequency information of all of the communication nodes that form the network does not need to be transferred, thereby improving the efficiency of the transferring process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A communication node in a network to which a plurality of communication nodes are connected and in which a cut-and-through scheme communication is performed using a plurality of frequencies in a multi-hop fashion, the communication node comprising:
a transmitting unit configured to insert, in a packet, information of a frequency used for transmission by the communication node, and to transmit the packet to a destination communication node; and
a frequency selecting unit configured to select, as a transmission frequency of the communication node, a frequency that is not used by a source communication node in accordance with the information of a frequency inserted in the received packet.

2. The communication node according to claim 1, wherein
information of a communication quality is included as information of the frequency, and
the communication node performs carrier-sensing for an available frequency, and sets a frequency indicating a highest communication quality as the transmission frequency.

3. The communication node according to claim 1, wherein
the communication node includes a non-directional antenna.

4. A communication method used by a communication node in a network to which a plurality of communication nodes are connected and in which a cut-and-through scheme communication is performed using a plurality of frequencies in a multi-hop fashion, the communication method comprising:
inserting, in a packet, information of a frequency used for transmission by the communication node, and transmitting the packet to a destination communication node; and
selecting, as a transmission frequency of the communication node, a frequency that is not used by a source communication node in accordance with the information of a frequency inserted in the received packet.

5. The communication method according to claim 4, wherein
information of a communication quality is included as information of the frequency, and
the communication node performs carrier-sensing for an available frequency, and sets a frequency indicating a highest communication quality as the transmission frequency.

6. The communication method according to claim 4, wherein
the communication node includes a non-directional antenna.
